(19) United States
(12) Patent Application Publication
(10) Pub. No.: US 2012/0173301 A1
(43) Pub. Date: Jul. 5, 2012

(54) SYSTEM AND METHOD FOR FAILURE ASSOCIATION ANALYSIS

(75) Inventors: Wei Shan Dong, Beijing (CN); Rogerio S. Feris, White Plains, NY (US); Arun Hampapur, Norwalk, CT (US); Zhong Bo Jiang, Beijing (CN); Shilpa N. Mahatma, Mohegan Lake, NY (US); Wei Sun, Beijing (CN); Lexing Xie, White Plains, NY (US)

(73) Assignee: INTERNATIONAL BUSINESS MACHINES CORPORATION, Armonk, NY (US)

(21) Appl. No.: 12/984,019

(22) Filed: Jan. 4, 2011

(51) Int. Cl. G06Q 10/00

(52) U.S. Cl. 705/7.28

(57) ABSTRACT

A system and method for mining the failure association rules of geographically dispersed physical assets is provided. One approach of the present invention has steps of joining input data sources, extracting spatio-temporal (ST) information, quantilizing ST continuous value in automated manner, or based on pre-built knowledge, applying association rule mining algorithm to find associations between attributes and failure and outputting identified ST failure association rules.

### RELATED APPLICATIONS

The present application is related in some aspects to commonly owned and co-pending application entitled “INFRASTRUCTURE ASSET MANAGEMENT”, having Attorney Docket No. END920100156US1, and U.S. patent application Ser. No. 12/983,556, filed on Jan. 3, 2011; and commonly owned and co-pending application entitled “A SYSTEM AND METHOD FOR RISK OPTIMIZED, SPATIALLY SENSITIVE PREVENTIVE MAINTENANCE SCHEDULING FOR ASSET MANAGEMENT”, having Attorney Docket No. END920100159US1, and U.S. patent application Ser. No. 12/954,051, filed on Nov. 29, 2010.

### FIELD OF THE INVENTION

The present invention relates generally to failure prediction and more specifically, to a method and a system for mining the failure association rules of geographically dispersed physical assets.

### BACKGROUND OF THE INVENTION

Many entities in the Smarter Planet arena run asset intensive businesses, e.g., water and power utilities, transportation operators, hotels, oil and gas companies, power plants, etc. One of the most significant components of their operating cost tends to be maintenance. Current solutions to the problem use a manual approach to recording and managing maintenance operations (e.g., scheduling, preventive maintenance, operating parameter control, etc). Failure pattern identification is a critical issue for asset management, especially asset maintenance. Usually failures of assets are caused by multiple factors, including internal factors (e.g., manufacturing technology) and external factors (e.g., usage pattern, weather condition, location and time). There is a problem in identifying failure patterns quickly and effectively, and make asset management more efficient and effective. This problem is widely applicable to many industries as well, including transportation, energy, public facilities, telecom and other industries.

Therefore, there exists a need for a solution that solves at least one of the deficiencies of the related art.

### SUMMARY OF THE INVENTION

The present invention may comprise a system and method for mining the failure association rules of geographically dispersed physical assets. Failure pattern identification is a critical issue for asset management, especially asset maintenance. Usually failures of assets are caused by multiple factors, including internal factors (e.g., manufacturing technology) and external factors (e.g., usage pattern, weather condition, location and time). The present invention can identify failure patterns quickly and effectively, and make asset management more efficient and effective.

The present invention may further comprise a method for mining the failure association rules of geographically dispersed physical assets comprising modeling asset failure pattern considering spatial and temporal correlation, extracting, automatically, spatio-temporal attributes and quantilizing, automatically, a continuous spatio-temporal value.

The present invention may further comprise a computer-readable medium storing computer instructions, which, when executed, enables a computer system operating for mining the failure association rules of geographically dispersed physical assets comprising modeling asset failure pattern considering spatial and temporal correlation, extracting, automatically, spatio-temporal attributes and quantilizing, automatically, a continuous spatio-temporal value.

The present invention may further include a method for deploying a system for mining the failure association rules of geographically dispersed physical assets comprising modeling asset failure pattern considering spatial and temporal correlation, extracting, automatically, spatio-temporal attributes, and quantilizing, automatically, a continuous spatio-temporal value.

The present invention may further comprise system having at least one processing unit and memory for mining the failure association rules of geographically dispersed physical assets comprising: a failure association rules mining processing unit; and input data memory.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a data processing system suitable for mining the failure association rules of geographically dispersed physical assets of the present invention.

FIG. 2 shows a network that may incorporate an embodiment of the present invention.

FIG. 3 illustrates a system of the present invention for mining the failure association rules of geographically dispersed physical assets.

FIG. 4 illustrates a method of the present invention for mining the failure association rules of geographically dispersed physical assets.

The drawings are merely schematic representations, not intended to portray specific parameters of the invention. The drawings are intended to depict only typical embodiments of the invention, and therefore should not be considered as limiting the scope of the invention.

### DETAILED DESCRIPTION OF THE DRAWINGS

Exemplary embodiments now will be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

The present invention, which meets the needs identified above, provides for a method and a system for mining the failure association rules of geographically dispersed physical assets to identify failure patterns quickly and effectively, which makes asset management more efficient and effective.

This invention considers spatio-temporal information in failure association rule mining for geographically dispersed physical assets. Spatial-temporal reasoning aims at describing the common-sense background knowledge on which our human perspective on the physical reality is based. The mining process finds linkage among assets' internal attributes, external factors like environmental variables, and historic failure records as follows:

Input data=asset internal attributes+external data+historical failure records

As used herein, embodiments of the invention will be described using the following definitions:
1. Internal attributes: Model/make/specification/parameter, etc.
2. External data: Spatial info (location of asset, lat/long, address or zip code), temporal information (failure time), environmental variables such as weather condition, demographical data, etc.
3. Failure records: e.g., work orders.
   Continuous: Numerical attributes need quantilization
   Algorithm: Association rule mining algorithm (e.g., Apriori-Apriori is a classic algorithm for learning association rules.)

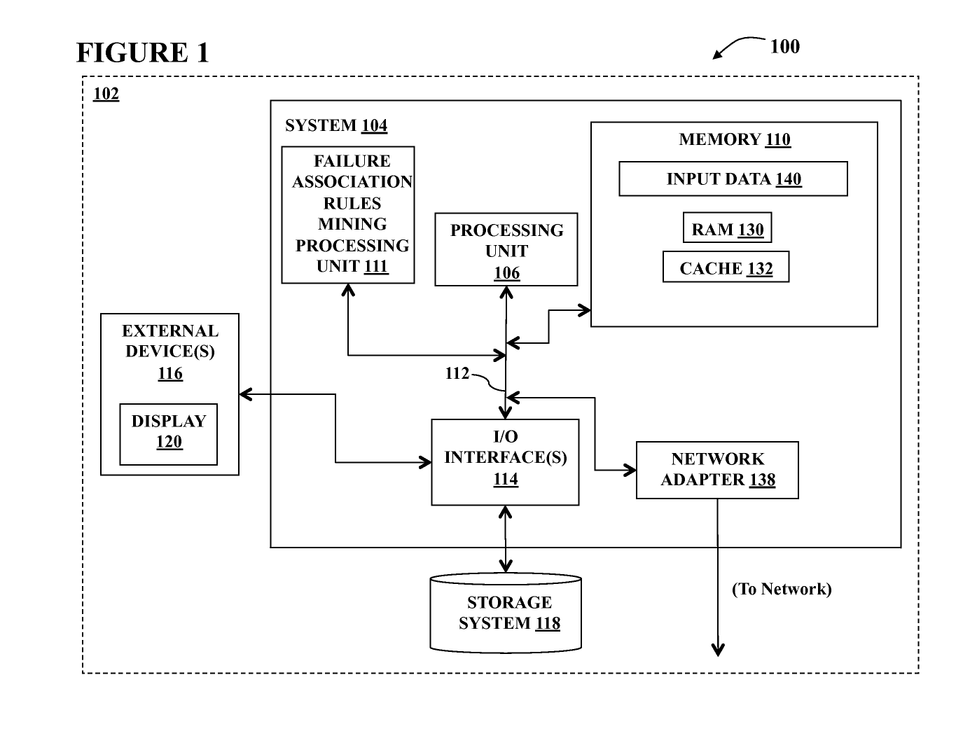

System 100, such as Data Processing System 102 shown in FIG. 1, suitable for storing and/or executing program code of the present invention may include Failure Association Rules Mining Processing Unit 111 and at least one processor (Processing Unit 106) coupled directly or indirectly to Memory 110 through System Bus 112. Memory 110 may include local memory (RAM 130) employed during actual execution of the program code and cache memories (Cache 132) that provide temporary storage of at least some program code in order to reduce the number of times code must be retrieved from Bulk Storage 118, connected to Input Data 140, during execution.

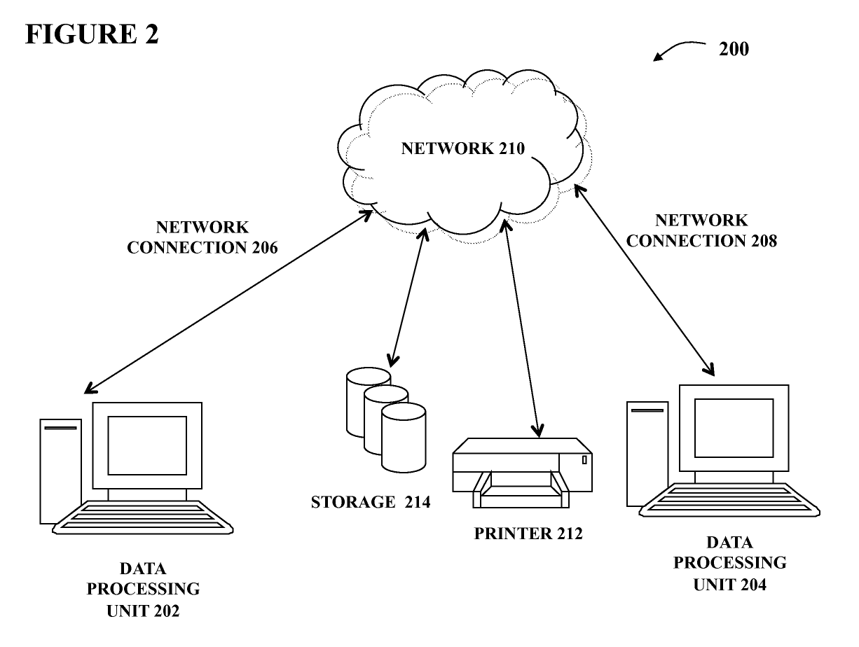

Input/output or I/O devices (External Devices 116) (including but not limited to keyboards, displays (Display 120), pointing devices, etc.) can be coupled to System 104 (see FIG. 1), either directly or indirectly through a network (see FIG. 2) through intervening I/O controllers (I/O interface(s) 114).

Network adapters (Network Adapter 138 in FIG. 1) may also be utilized in System 200 to enable data processing units (as shown in FIG. 2, Data Processing Unit 202) to become coupled through network connections (Network Connections 206, 208) to other data processing units (Data Processing Unit 204), remote printers (Printer 212) and/or storage devices (Storage 214) or other devices through intervening private and/or public networks (Network 210).

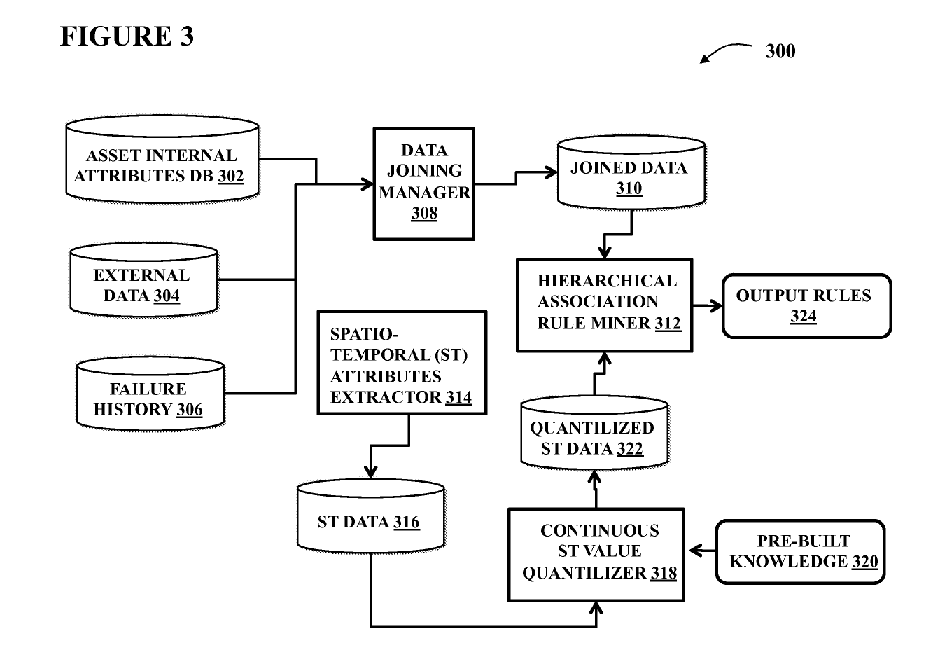

FIG. 3 illustrates System 300 for mining the failure association rules of geographically dispersed physical assets. Data from Asset Internal Attributes DB 302, External Data 304 and Failure History 306 is fed to Data Joining Manager 308 for joining the data and then is passed Joined Data DB 310. Joined data is passed to Hierarchical Association Rule Miner 312. Spatio-Temporal (ST) Attributes Extractor 314 extracts ST Data 316. Continuous ST Value Quantilizer 318 continuously quantilizes ST Data 316. Pre-Built Knowledge 320 is also fed to Continuous ST Value Quantilizer 318. Quantilized ST Data 322 is fed to Hierarchical Association Rule Miner 312 which creates and outputs Output Rules 324.

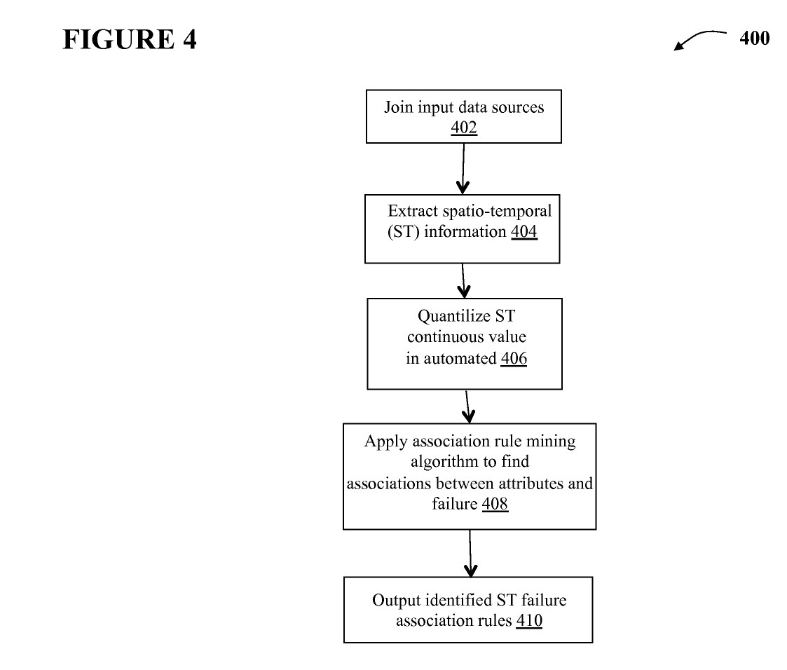

FIG. 4 illustrates one method 400 of the present invention. The steps of the method are as follows:
1. Join input data sources 402. Data sources may include:
   Asset internal attributes
   External data
   Failure history
2. Extract spatio-temporal (ST) information 404;
3. Quantilize ST continuous value in automated manner, or based on pre-built knowledge 406;
4. Apply association rule mining algorithm to find associations between attributes and failure 408; and
5. Output identified ST failure association rules 410.

It should be understood that the present invention is typically computer-implemented via hardware and/or software. As such, client systems and/or servers will include computerized components as known in the art. Such components typically include (among others) a processing unit, a memory, a bus, input/output (I/O) interfaces, external devices, etc.

Shown and described herein is a system and method for mining the failure association rules of geographically dispersed physical assets. For example, in one embodiment, the invention provides a computer-readable/useable medium that includes computer program code to enable a system for mining the failure association rules of geographically dispersed physical assets. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory and/or storage system (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a computer-implemented method for mining the failure association rules of geographically dispersed physical assets. In this case, a computerized infrastructure can be provided and one or more systems for performing the process steps of the invention can be obtained (e.g., created, purchased, used, modified, etc.) and deployed to the computerized infrastructure. To this extent, the deployment of a system can comprise one or more of (1) installing program code on a computing device, such as computer system from a computer-readable medium; (2) adding one or more computing devices to the computer infrastructure; and (3) incorporating and/or modifying one or more existing systems of the computer infrastructure to enable the computerized infrastructure to perform the process steps of the invention.

As used herein, it is understood that the terms “program code” and “computer program code” are synonymous and may mean any expression, in any language, code or notation, of a set of instructions intended to cause a computing device having an information processing capability to perform a particular function either directly before or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

In another embodiment, the invention provides a business method that performs the process steps of the invention on a subscription, advertising, and/or fee basis. That is, a service provider, such as a solution integrator, could offer to deploy a computer infrastructure for mining the failure association rules of geographically dispersed physical assets. In this case, the service provider can create, maintain, and support, etc., the computer infrastructure by integrating computer-readable code into a computing system, wherein the code in combination with the computing system is capable of performing the process steps of the invention for one or more customers. In return, the service provider can receive payment from the customer(s) under a subscription and/or fee agreement and/or the service provider can receive payment from the sale of advertising content to one or more third parties.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for mining the failure association rules of geographically dispersed physical assets comprising:
modeling asset failure pattern considering spatial and temporal correlation;
extracting, automatically, spatio-temporal attributes; and
quantilizing, automatically, a continuous spatio-temporal value.

2. The method in claim 1 further comprising taking into account additional environment variables for failure association mining.

3. The method in claim 2 further comprising considering spatial-temporal correlation in relation to association rule mining.

4. The method in claim 3 further comprising basing the failure association rule mining on historic data.

5. The method in claim 4 further comprising recording the historic failure data.

6. A computer-readable medium storing computer instructions, which, when executed, enables a computer system having at least one processor and memory to implement a method for mining the failure association rules of geographically dispersed physical assets, the method comprising:
modeling asset failure pattern considering spatial and temporal correlation;
extracting, automatically, spatio-temporal attributes; and
quantilizing, automatically, a continuous spatio-temporal value.

7. The computer-readable medium in claim 6 wherein the method further comprises taking into account additional environment variables for failure association mining.

8. The computer-readable medium in claim 7 wherein the method further comprises considering spatial-temporal correlation in relation to association rule mining.

9. The computer-readable medium in claim 8 wherein the method further comprises basing the failure association rule mining on historic data.

10. The computer-readable medium in claim 9 wherein the method further comprises recording the historic failure data at regular or irregular intervals.

11. A method for deploying a system for mining the failure association rules of geographically dispersed physical assets comprising:
modeling asset failure pattern considering spatial and temporal correlation;
extracting, automatically, spatio-temporal attributes; and
quantilizing, automatically, a continuous spatio-temporal value.

12. The method in claim 11 further comprising taking into account additional environment variables for failure association mining.

13. The method in claim 12 further comprising considering spatial-temporal correlation in relation to association rule mining.

14. The method in claim 13 further comprising basing the failure association rule mining on historic data.

15. The method in claim 14 further comprising recording the historic failure data at regular or irregular intervals.

16. A system having at least one processing unit and memory for mining the failure association rules of geographically dispersed physical assets comprising:
a failure association rules mining processing unit; and
input data memory.

17. The system as defined in claim 16 further comprising a spatio-temporal (ST) attributes extractor.

18. The system as defined in claim 17 further comprising a data joining manager for receiving information from asset internal attributes database, external data database and failure history database and joining that data.

19. The system as defined in claim 18 further comprising a continuous ST value quantilizer for receiving ST data and pre-built knowledge.

20. The system as defined in claim 19 further comprising a hierarchical association rule miner for receiving joined data and quantilized ST data and producing output rules.
